(19) United States
(12) Patent Application Publication
(10) Pub. No.: US 2025/0014235 A1
(43) Pub. Date: Jan. 9, 2025

(54) MAP IMAGE PROCESSING DEVICE, MAP IMAGE PROCESSING METHOD AND COMPUTER-READABLE STORAGE MEDIUM

(71) Applicant: MediaTek Singapore Pte. Ltd., Singapore (SG)

(72) Inventor: Yuesheng WANG, Anhui (CN)

(21) Appl. No.: 18/764,832

(22) Filed: Jul. 5, 2024

(30) Foreign Application Priority Data
Jul. 6, 2023 (CN) 202310829707.2

(51) Int. Cl. G06T 11/00; G06T 7/90

(52) U.S. Cl. CPC G06T 11/001; G06T 7/90; G06T 2207/10024

(57) ABSTRACT

A map image processing method and device are provided. The map image processing method includes obtaining a map image to be processed and highlighting a focus color in the map image to obtain a highlighted image. The present application can highlight important information in the image by highlighting the focus color in the image, so that the important information in the image can be quickly and easily obtained.

### CROSS REFERENCE TO RELATED APPLICATIONS

This application claims priority of China Patent Application No. 202310829707.2, filed on Jul. 6, 2023, the entirety of which is incorporated by reference herein.

### BACKGROUND OF THE INVENTION

### Field of the Invention

The present invention relates to the field of image processing technology, and, in particular, to a method and device for processing a map image.

### Description of the Related Art

With the rapid development of mobile devices, the ways of presenting information are becoming more and more diverse. Presenting information through videos or images is a very intuitive and convenient method, and it occupies an increasingly large proportion of our daily communications.

In work and life, we often use mobile devices to present some visual information to obtain relevant information. Although video and image presentation is more intuitive, it is difficult to quickly obtain important information because it has no focal point. For example, in a car navigation scenario, the driver spends more time focusing on the screen while driving to obtain important information from the navigation screen.

### BRIEF SUMMARY OF THE INVENTION

The present application provides a map image processing method and device.

The map image processing method and device can highlight a focus color in an image to highlight the important information in the image. Therefore, the important information in the image can be easily and quickly obtained.

To achieve the above goals, the present application provides a map image processing method, comprising acquiring a map image to be processed, and highlighting the focus color in the map image to obtain a highlighted image.

To achieve the above goals, the present application also provides an image processing device, including a memory and a processor. The memory and the processor are coupled to each other. The processor is configured to execute program instructions stored in the memory to implement the above method.

To achieve the above goals, the present application also provides a computer-readable storage medium, configured to store instructions/program data. The instructions/program data can be executed to implement the above method.

The present application obtains a map image to be processed. Then, it highlights the focus color in the obtained map image to obtain a highlighted image, so that the focus color in the image can be highlighted when the image is displayed. This helps users to intuitively and quickly obtain important information from the video or image.

### BRIEF DESCRIPTION OF THE DRAWINGS

The accompanying drawings described herein provide a further understanding of the present application and constitute a part of the present application. The illustrative embodiments of the present application and their descriptions explain the present application and do not constitute an improper limitation on the present application. In the drawings:

FIG. 1 is a flowchart of an embodiment of a map image processing method of the present application;

FIG. 2 is a flowchart of another embodiment of the map image processing method of the present application;

FIG. 3 is a schematic diagram of the HSV space;

FIG. 4 is a schematic diagram of an HSV histogram in the map image processing method of the present application;

FIG. 5 is a schematic diagram of a map image to be processed in the map image processing method of the present application;

FIG. 6 is a schematic diagram of a highlighted image in the map image processing method of the present application;

FIG. 7 is a schematic diagram of the structure of an embodiment of the image processing device of the present application;

FIG. 8 is a schematic diagram of the structure of an embodiment of a computer-readable storage medium of the present application.

### DETAILED DESCRIPTION OF THE INVENTION

With the accompanying drawings in the embodiments of the present application, the technical solutions in the embodiments of the present application will be clearly and completely described below. Obviously, the described embodiments are only a part of the embodiments of the present application, rather than all of the embodiments. Based on the embodiments in the present application, all other embodiments obtained by those of ordinary skill in the art without making creative work are within the scope of protection of the present application. In addition, unless otherwise specified (e.g., “or in addition” or “or in an alternative”), the term “or” used herein refers to a non-exclusive “or” (i.e., “and/or”). Moreover, the various embodiments described herein are not necessarily mutually exclusive, because some embodiments can be combined with one or more other embodiments to form new embodiments.

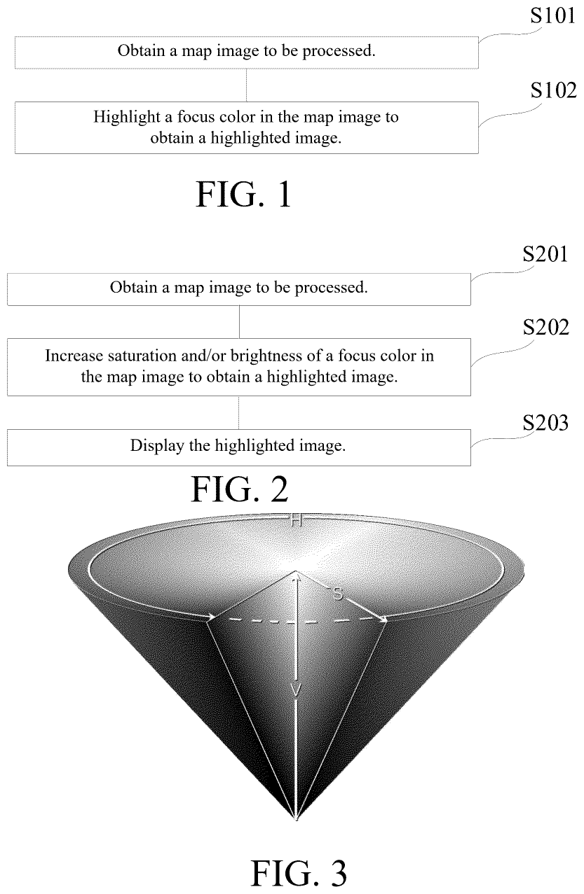

The present application provides a map image processing method. As shown in FIG. 1, the map image processing method of the present application includes the following steps. Optionally, the map image processing method of the present application can be applied to an image processing device. The image processing device can be a mobile phone, a computer, a car navigation and other devices. The image processing device is not specifically limited here. It should be noted that the following step numbers are only used for simplifying the description and are not intended to limit the execution order of the steps. The steps of this embodiment can be arbitrarily changed in execution order without violating the technical ideas of the present application.

S101: A map image to be processed is obtained.

A map image to be processed can be obtained first, so that a focus color in the map image can be highlighted later to obtain a highlighted image. As a result, the information presented by the focus color in the image can be highlighted when the image is displayed. Accordingly, the user can intuitively and quickly obtain important information on the video or image.

Wherein, the method for obtaining the map image to be processed is not limited. Specifically, the map image to be processed may be taken by a camera, or may be obtained from other devices such as a server. For example, the map image to be processed may be a navigation image obtained from a server.

S102: A focus color in the map image is highlighted to obtain a highlighted image.

After the map image to be processed is obtained, a focus color in the map image can be highlighted to obtain a highlighted image.

Wherein, the focus color can be a color of important information displayed in the map image, i.e., the color of the information in the map image that a user pays special attention to.

Optionally, the focus color may be determined according to the usage scenario of the map image. For example, if the usage scenario is a vehicle navigation scenario, the focus color may include yellow for displaying lane planning information, blue, red and green for displaying signboards, and/or green, yellow and red for displaying road conditions.

In an embodiment, steps of highlighting the focus color in the map image may include increasing saturation and/or brightness of the focus color in the map image.

In another embodiment, steps of highlighting the focus color in the map image may include reducing saturation and/or brightness of colors other than the focus color in the map image. As a result, the saturation and/or brightness of the focus color is relatively increased. Accordingly, the focus color in the map image is highlighted.

Wherein, a color processing unit can be configured to highlight the focus color in the map image to obtain the highlighted image.

In addition, after the highlighted image is obtained based on step S102, the highlighted image can be displayed, so that the user can quickly obtain important information on the video or image through the display screen. In one embodiment, the highlighted image can be transmitted to the display control unit, so that the display control unit can transmit the highlighted image to the display unit for display. In another embodiment, the highlighted image can be transmitted to another device, so that another device can display the highlighted image.

In this embodiment, the map image to be processed is obtained. Then, the focus color in the map image is highlighted to obtain the highlighted image. Therefore, the focus color in the map image can be highlighted when displayed. As a result, the user can intuitively and quickly obtain important information on the video or image.

The present application proposes another method for processing a map image. As shown in FIG. 2, the map image processing method of the present application includes the following steps. It should be noted that the following step numbers are only used for simplifying the description and are not intended to limit the execution order of the steps. The steps of this embodiment can be arbitrarily changed in execution order without violating the technical idea of the present application.
S201: A map image to be processed is obtained.
S202: Saturation and/or brightness of a focus color in the map image are increased to obtain a highlighted image.

In one embodiment, the saturation of the focus color in the map image can be uniformly increased by a first value, and/or the brightness of the focus color in the map image can be uniformly increased by a second value. The first value and the second value can be set according to actual conditions and are not limited here.

For example, the saturation and brightness of the focus color in the map image are uniformly increased, and the global saturation of the map image is overall increased.

In another embodiment, the saturation and/or brightness of the focus color in the map image can be increased based on adaptability of ambient brightness. Preferably, the ambient brightness is a positive factor affecting the amount of increase in the saturation and/or brightness of the focus color. More preferably, the amount of increase in the saturation and/or brightness of the focus color is positively correlated with the current ambient brightness (i.e., the higher the ambient brightness, the higher the amount of increase in the saturation and/or brightness of the focus color). Therefore, adaptively increasing the saturation and/or brightness of the focus color according to the ambient brightness can enhance the highlighting effect of the focus color.

Wherein, the ambient brightness may be detected in real time by an ambient brightness detection unit in the image processing device.

In another embodiment, the map image may be analyzed to obtain an analysis result of the map image. Based on the analysis result, the saturation and/or brightness of each focus color may be increased.

That is, distribution of each focus color in the map image can be analyzed. Then, the saturation and/or brightness of the focus color in the map image can be improved based on the distribution of each focus color. For example, the appearance of each focus color in the map image can be analyzed, and the saturation and/or brightness of the focus color in the map image can be improved.

Optionally, the distribution value of each focus color in the map image may be analyzed. Then, the brightness and/or saturation of each focus color in the map image may be increased based on the distribution value of each focus color in the map image.

Specifically, the amount of increase in the saturation and/or brightness of each focus color may be determined based on the distribution value of each focus color in the map image.

Preferably, the distribution value of the focus color is a positive factor affecting the amount of increase in the saturation and/or brightness of the focus color. That is, the amount of increase in the saturation and/or brightness of the focus color with a large distribution value is higher than or equal to that of the focus color with a small distribution value. In this way, the information presented by the focus color with a distribution value can be further highlighted in the displayed image. Furthermore, the distribution value of the focus color can be positively correlated with the increase in saturation and/or brightness of the focus color.

Of course, in other embodiments, the distribution value of the focus color is a negative factor affecting the increase in the saturation and/or brightness of the focus color. That is, the increase in the saturation and/or brightness of the focus color with a large distribution value is lower than or equal to that of the focus color with a small distribution value. In this way, the information corresponding to the focus color with a small distribution value can be further highlighted in the displayed image. As a result, the user can quickly obtain the information corresponding to the focus color with a large distribution value. Moreover, the user can also quickly obtain the information corresponding to the focus color with a small distribution value based on the greatly improved saturation and/or brightness. This facilitates the user to quickly obtain important information corresponding to various focus color. Furthermore, the distribution value of the focus color can be negatively correlated with the amount of increase in the saturation and/or brightness of the focus color.

Optionally, a histogram of at least one of the channels of the map image can be analyzed to obtain an analysis result of the map image, wherein the channels may include a Y channel, an R channel, a G channel, a B channel, an H channel, an S channel and a V channel.

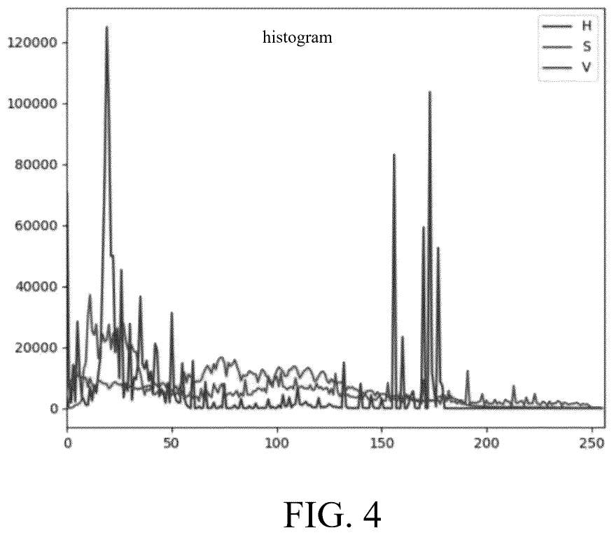

For example, a color histogram of an HSV space of the map image shown in FIG. 3 can be analyzed. For example, the histogram of the H channel of the map image shown in FIG. 4 can be analyzed to determine the distribution value of each focus color in the map image to be processed. Specifically, proportion of different colors in the entire image can be determined through the histogram of the H channel of the map image. This determines the distribution value of each focus color in the map image.

Of course, in some embodiments, a color histogram of a Luv space or a Lab space can also be analyzed to determine the distribution of each focus color in the map image.

Optionally, the map image to be processed may be analyzed by an image processing unit, e.g., special hardware, a CPU or a GPU.

In another embodiment, in response to a change in the ambient brightness, the saturation and/or brightness of the map image to be processed may be uniformly adjusted based on the current ambient brightness to obtain a first adjustment image. Then, the saturation and/or brightness of the focus color in the first adjustment image may be increased to obtain the highlighted image. In another embodiment, the saturation and/or brightness of other colors in the first adjustment image except the focus color may be reduced to highlight the focus color in the first adjustment image to obtain the highlighted image. S203: The highlighted image is displayed.

In addition, whether to use the map image processing method of the above embodiment to highlight the map image can be determined based on a current usage scenario of the image processing device.

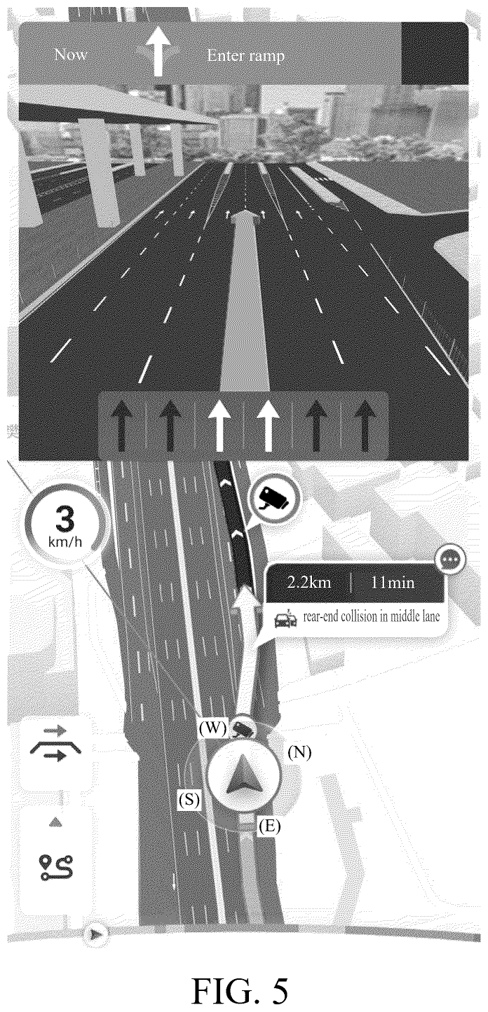

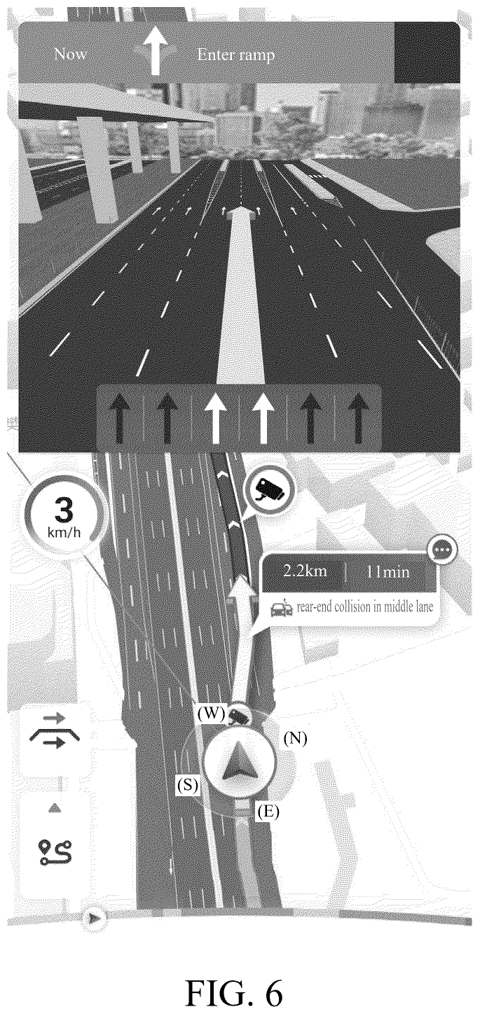

For example, when the current usage scenario of the image processing device is a map navigation scenario, the map image processing method of the above embodiment can be configured to highlight the map image. For example, when the current usage scenario is a map navigation scenario, the map image shown in FIG. 5 can be highlighted by the map image processing method of the above embodiment to obtain the highlighted image shown in FIG. 6. The focus colors (i.e., the red color indicating the road condition and the yellow color indicating the route) are both highlighted, so that the user can more easily notice the navigation information and changes in road conditions.

Alternatively, when the current usage scenario of the image processing device is an image color enhancement scenario and a color to be enhanced is set, the color to be enhanced can be set as the focus color. Then, the map image processing method of the above-mentioned embodiment can be configured to highlight the map image.

Optionally, the current usage scenario of the image processing device can be determined based on the application currently used by the image processing device and its running function. Of course, in some embodiments, the current usage scenario of the image processing device can also be determined by AI analyzing the map image. In addition, AI can analyze user preferences based on historical usage data of different users to determine whether to enable the function of map image highlighting.

In addition, in some embodiments, whatever the current usage scenario is, the map image processing method of the above-mentioned embodiment can be configured to highlight the map image.

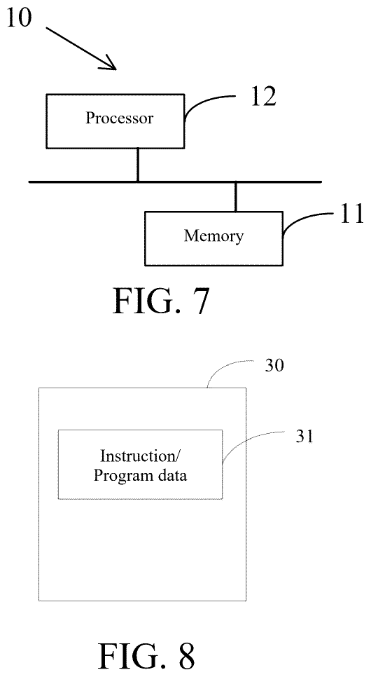

Referring to FIG. 7, FIG. 7 is a schematic diagram of the structure of an embodiment of the image processing device of the present application. The image processing device 10 includes a processor 12. The processor 12 is configured to execute instructions that implement the above map image processing method. The specific implementation process can be found in the description of the above embodiment. It will not be repeated here.

The processor 12 may also be referred to as a central processing unit (CPU). The processor 12 may be an integrated circuit chip with signal processing capabilities. The processor 12 may also be a general-purpose processor, a digital signal processor (DSP), an application-specific integrated circuit (ASIC), a field programmable gate array (FPGA), or other programmable logic devices, discrete gates or transistor logic devices, discrete hardware components. A general-purpose processor may be a microprocessor. Alternatively, the processor 12 may also be any conventional processor, etc.

The image processing device 10 may further include a memory 11 storing instructions and data for the processor 12 to run.

The processor 12 is configured to execute instructions that implement the method provided by any embodiment of the prediction method and video encoding method of the present application and any non-conflicting combination.

Referring to FIG. 8, FIG. 8 is a schematic diagram of the structure of a computer-readable storage medium in an embodiment of the present application. The computer-readable storage medium 30 of the embodiment of the present application stores instructions/program data 31. When the instructions/program data 31 are executed, the method provided by any embodiment of the map image processing method of the present application and any non-conflicting combination is implemented. The instructions/program data 31 can form a program file stored in the above-mentioned storage medium 30 in the form of a software product. Therefore, a computer device (e.g., a personal computer, a server, or a network device, etc.) or a processor can execute all or partial steps of the methods of each embodiment of the present application. The aforementioned storage medium 30 includes universal serial bus (USB), mobile hard disk, read-only memory (ROM), random access memory (RAM), disk, optical disk, any medium that can store program codes, or terminal devices such as computers, servers, mobile phones, and tablets.

In the several embodiments provided in the present application, it should be understood that the disclosed systems, devices and methods can be implemented in other ways. For example, the device embodiments described above are only schematic. For example, the division of units is only a logical function division. There may be other division methods in actual implementation. For example, multiple units or components can be combined or integrated into another system, or some features can be ignored or not executed. On the other hand, the mutual coupling or direct coupling or communication connection shown or discussed can be an indirect coupling or communication connection through some interfaces, devices or units in electrical, mechanical or other forms.

In addition, each functional unit in each embodiment of the present application may be integrated into one processing unit, or each may exist physically separately, or two or more may be integrated into one. The above-mentioned integrated unit may be implemented in the form of hardware or software functional units.

It should also be noted that the terms “include”, “comprises” or any other variations are intended to cover non-exclusive inclusion. As a result, a process, method, commodity or device including a series of elements includes not only those elements other elements not explicitly listed, or also includes elements inherent to such process, method, commodity or device. Without more restrictions, the elements defined by the sentence “comprises a . . . ” do not exclude the existence of other identical elements in the process, method, commodity or device including the elements.

The above are only embodiments of the present application, and are not intended to limit the patent scope of the present application. Any equivalent structure or equivalent process transformation made using the contents of the present application specification and drawings, or directly or indirectly applied in other related technical fields, are also included in the patent protection scope of the present application.

What is claimed is:

1. A map image processing method, comprising:
obtaining a map image to be processed; and
highlighting a focus color in the map image to obtain a highlighted map image.

2. The map image processing method as claimed in claim 1, wherein the step of highlighting the focus color in the map image to obtain the highlighted map image comprises:
increasing saturation or brightness of the focus color.

3. The map image processing method as claimed in claim 2, wherein the step of highlighting the focus color in the map image to obtain the highlighted map image comprises:
analyzing the map image to obtain an analysis result of the map image; and
increasing the saturation or brightness of the focus color based on the analysis result.

4. The map image processing method as claimed in claim 3, wherein the analysis result of the map image comprises distribution of each focus color in the map image;
wherein an amount of increase in the saturation or brightness of the focus color is positively correlated to a distribution value of the focus color.

5. The map image processing method as claimed in claim 4, wherein the step of analyzing the map image to obtain the analysis result of the map image comprises:
analyzing a histogram of at least one channel of the map image to obtain the analysis result, wherein the at least one channel of the map image comprises a Y channel, an R channel, a G channel, a B channel, an H channel, an S channel and a V channel.

6. The map image processing method as claimed in claim 1, wherein the step of highlighting the focus color in the map image to obtain the highlighted map image comprises:
increasing saturation or brightness of the focus color based on an ambient brightness:
wherein an amount of increase in the saturation or brightness of the focus color is positively correlated to the ambient brightness.

7. The map image processing method as claimed in claim 1, wherein the step of highlighting the focus color in the map image to obtain the highlighted map image comprises:
determining the focus color in the map image based on a current scenario.

8. The map image processing method as claimed in claim 1, wherein the step of highlighting the focus color in the map image to obtain the highlighted map image comprises:
in a map navigation scenario, highlighting the focus color in the map image to obtain the highlighted map image:
wherein the map image processing method further comprises displaying the highlighted map image after the step of highlighting the focus color in the map image to obtain the highlighted map image.

9. A map image processing device, comprising a memory and a processor, wherein the memory and the processor are coupled to each other, wherein the processor is configured to execute program instructions stored in the memory to implement the method as claimed in claim 1.

10. A map image processing device, comprising a memory and a processor, wherein the memory and the processor are coupled to each other, wherein the processor is configured to execute program instructions stored in the memory to implement the method as claimed in claim 2.

11. A map image processing device, comprising a memory and a processor, wherein the memory and the processor are coupled to each other, wherein the processor is configured to execute program instructions stored in the memory to implement the method as claimed in claim 3.

12. A map image processing device, comprising a memory and a processor, wherein the memory and the processor are coupled to each other, wherein the processor is configured to execute program instructions stored in the memory to implement the method as claimed in claim 4.

13. A computer-readable storage medium, configured to store instructions/program data, wherein the instructions/program data implement the method as claimed in claim 1 when executed.

14. A computer-readable storage medium, configured to store instructions/program data, wherein the instructions/program data implement the method as claimed in claim 2 when executed.

15. A computer-readable storage medium, configured to store instructions/program data, wherein the instructions/program data implement the method as claimed in claim 3 when executed.

16. A computer-readable storage medium, configured to store instructions/program data, wherein the instructions/program data implement the method as claimed claim 4 when executed.
